(19) United States
(12) Patent Application Publication
(10) Pub. No.: US 2001/0045390 A1
(43) Pub. Date: Nov. 29, 2001

(54) Wastewater treatment process

(76) Inventors: Sungtai Kim, Wayne, NJ (US); Alan H. Molof, New City, NY (US); Eul-Saeng Cho, Fort Lee, NJ (US)

Correspondence Address: Barry Evans, Esq., KRAMER LEVIN NAFTALIS & FRANKEL LLP, 919 THIRD AVENUE, NEW YORK, NY, 10022, US

(21) Appl. No.: 09/792,493

(22) Filed: Feb. 23, 2001

Related U.S. Application Data
(60) Provisional application No. 60/184,612, filed on Feb. 24, 2000.

(51) Int. Cl. C02F 3/30; C02F 3/00

(52) U.S. Cl. 210/605; 210/609; 210/621; 210/623; 210/630

(57) ABSTRACT

A wastewater treatment process providing nitrogen, phosphorus, biochemical oxygen demand (BOD) and suspended solids removal comprises the steps of:

passing wastewater containing ammonia nitrogen, phosphate, BOD and suspended solids, said wastewater mixed with recycled activated sludge from a subsequent step, into a first anoxic zone therein reducing nitrate nitrogen from the recycled sludge to molecular nitrogen;

passing effluent from the first anoxic zone to a first aerobic zone therein oxidizing at least a portion of the BOD and oxidizing at least a portion of the ammonia nitrogen to nitrate nitrogen;

recycling a portion of the contents at the end of the first aerobic zone back to the first anoxic zone;

passing the effluent of the first aerobic zone to a second anoxic zone;

introducing volatile fatty acid such as acetic acid into the second anoxic zone therein releasing phosphorus into a liquid phase;

passing effluent from the second anoxic zone including the volatile fatty acid to a second aerobic zone therein substantially absorbing phosphorus into biomass and removing and/or oxidizing ammonia nitrogen;

passing effluent from the second anoxic zone to a final settling zone therein separating:

(i) a purified wastewater having decreased nitrogen, phosphorus, BOD and suspended solids and

(ii) a sludge containing suspended solids, phosphate and BOD; and recycling at least a portion of the sludge (ii) to the first anoxic zone.

In another embodiment, at least a portion of the sludge (ii) is also recycled to the second anoxic zone. In yet another embodiment, the second anoxic zone is divided into a first section and a second section. In the first section, anoxic conditions are established and in the second section, volatile fatty acid is added after anoxic conditions have been established.

### FIELD OF THE INVENTION

This invention relates broadly to process improvements in nutrient removal wastewater treatment processes. More specifically, this invention relates to methods for improving the efficiency of nitrogen and phosphorous removal. Even more specifically, this invention relates to methods for integrating an activated sludge process with methods for improving nutrient removal in wastewater treatment processes. In addition this invention relates to the conduct of such processes in order to improve the efficiency of removal of suspended solids and biochemical oxygen demand.

### BACKGROUND OF THE INVENTION

There are basically two processes for the biological or secondary treatment of wastewater, including a slurry type process and a process utilizing a biological fixed-film. In both processes, raw wastewater is settled in a primary settling zone before effluent is passed to a secondary or biological oxidation zone. The settling zone removes suspended solids resulting in a reduction in particulate Biochemical Oxygen Demand (BOD), nitrogen and phosphorous.

One of the biological oxidation processes is characterized by the slurry type of process in which suspended solids in the mixed liquor (MLSS) are aerated and mixed in an aeration tank which can be either a complete mix reactor, or more usually, a plug flow reactor. After the aeration tank, the treated wastewater with its suspended solids passes to a final settling tank where the suspended solids are settled and a portion of the settled suspended solids is recycled back to the entrance to the aeration tank. Another portion of the settled suspended solids is removed from the system as waste activated sludge (WAS). The process can also be done on a batch basis in a sequencing batch reactor (SBR).

The second type of secondary biological treatment is characterized by a biological fixed film. One type of biological fixed-film is a trickling filter which passes settled wastewater over a static rock or plastic media. The effluent from the trickling filter media containing treated wastewater and suspended solids is passed to a final settling tank where a portion of the clarified effluent is recycled back to the feed to the trickling filter. The settled suspended solids in the final settling tank are removed from the liquid system. The other type of fixed-film treatment is the rotating biological contactor (RBC) in which the fixed-film is attached to a rotating disk in a tank containing the wastewater being treated. This process usually is divided into three or four stages of rotating disks. The effluent containing treated wastewater and suspended solids is passed to a final settling tank separating the clarified effluent from the settled suspended solids. The settled suspended solids in the final settling tank are removed from the liquid system.

An Activated Sludge process treats settled wastewater by the use of aeration tanks under aerobic conditions where dissolved oxygen is present at a minimum of about 2 mg/l. This aeration process converts soluble and colloidal organic matter into new biomass and carbon dioxide by oxidation. The biomass is settled in a final settling tank or clarifier and the settled biomass or active sludge is recycled back to the entrance to the aeration tank where it is mixed with the settled wastewater. The biomass is also reduced by endogenous respiration.

Many variations of the activated sludge process are possible. The one of interest to this invention is the MLE Activated Sludge Process (Modified Ludzac-Ettinger Process). The original process, LE, was the conversion of the initial part of the aeration tank to an anoxic zone (no dissolved oxygen but some nitrate) where return or active sludge is first mixed with settled wastewater in a zone without air or an anoxic zone. In this modification, any oxidation of ammonia nitrogen to nitrate by the aerobic section of the tank is exposed to the anoxic zone where nitrate nitrogen is reduced to nitrogen gas by denitrification. To increase the efficiency of nitrate removal, an inside recycle from the end of the aeration tank back to the entrance to the aeration tank or anoxic zone is added. This process flow is named the MLE Process.

The activated sludge process was later improved to remove not only nitrogen but also phosphorous. If an initial zone is anaerobic (no oxygen and no nitrate), phosphorous is released to the bulk liquid from the biomass. Following the anaerobic zone, an aerobic zone removes the released P from the liquid phase back into biomass. Many variations of this process have been developed including the Bardenpho and AO Processes.

These variations of the activated sludge process for nutrient removal present some difficulties. For example, sludge settling is a problem in the final settling tank as well as excess foaming in the aeration tank. In addition, there is a problem of insufficient removal of nitrogen and phosphorous so that additional steps are required. This includes the addition of chemicals such as alum or ferric chloride for phosphorus removal and chemicals such as methanol for denitrification. These additions result in excess sludge in phosphorus removal and excess tankage in nitrogen removal. The operation of these variations for nutrient removal also cause control problems such as the inability to match methanol with changing nitrate concentration resulting in overdosing of the methanol.

Fixed-film systems such as the trickling filter and RBC can contribute to biological nutrient removal only by oxidation of ammonia nitrogen to nitrate nitrogen. If nitrate and phosphorous are to be removed, extra tankage and/or chemicals are required. The general trend has been either to abandon the fixed-film process and construct an activated sludge nutrient removal plant, or to add an activated sludge nutrient removal system following the fixed-film process. These add excessive costs and extra operational problems for both options.

### OBJECTS OF THE INVENTION

It is thus the primary object of this invention to improve the efficiency of activated sludge nutrient removal processes.

It is a further and related object of this invention to improve the activated sludge MLE process for nutrient removal.

It is still a further and related object of this invention is to improve the removal of BOD, SS and turbidity.

It is still a further object of this invention to provide process modifications for future and existing activated sludge plants which enable such plants to remain as activated sludge plants with nutrient removal as a integral part of the process.

### SUMMARY OF THE INVENTION

This invention broadly includes methods for increasing nutrient removal in an activated sludge process. The invention broadly resides in a wastewater treatment process which includes treating wastewater with an activated sludge process including a two part anoxic zone, a two part aerobic zone and a settling zone with the recycle of settled biomass back to a first stage anoxic zone. In particular, the process of the invention involves recycle of settled biomass back to a first stage anoxic zone, followed by a first aerobic zone, and then to a second anoxic zone with addition of volatile fatty acid such as acetic acid, and then followed by a second aerobic zone.

In embodiments of the invention, a wastewater treatment process providing nitrogen, phosphorus, biochemical oxygen demand (BOD) and suspended solids removal comprises the steps of:

passing wastewater containing ammonia nitrogen, phosphate, BOD and suspended solids, said wastewater mixed with recycled activated sludge from a subsequent step, into a first anoxic zone therein reducing nitrate nitrogen from the recycled sludge to molecular nitrogen;

passing effluent from the first anoxic zone to a first aerobic zone therein oxidizing at least a portion of the BOD and oxidizing at least a portion of the ammonia nitrogen to nitrate nitrogen;

passing the effluent of the first aerobic zone to a second anoxic zone;

introducing volatile fatty acid such as acetic acid into the second anoxic zone therein releasing phosphorus into a liquid phase;

passing effluent from the second anoxic zone including the volatile fatty acid to a second aerobic zone therein substantially absorbing phosphorus into biomass and removing and/or oxidizing ammonia nitrogen;

passing effluent from the second anoxic zone to a final settling zone therein separating:

(i) a purified wastewater having decreased nitrogen, phosphorus, BOD and suspended solids and

(ii) a sludge containing suspended solids, phosphate and BOD; and recycling at least a portion of the sludge (ii) to the first anoxic zone.

In one embodiment, a portion of the contents at the end of the first aerobic zone is recycled to the first anoxic zone. In another embodiment, at least a portion of the sludge (ii) is also recycled to the second anoxic zone. In yet another embodiment, the second anoxic zone is divided into a first section and a second section. In the first section, anoxic conditions are established and in the second section, volatile fatty acid is added after anoxic conditions have been established.

The process can be used in existing plants or in new plants to substantially remove N and P. The process can be adapted for the unsettled affluent of fixed-film wastewater treatment processes such as rotating biological contractors (RBC) or trickling filters. The process of the invention results in substantial and significant improvement in the reduction of N and P levels in an economical manner.

### BRIEF DESCRIPTION OF THE DRAWINGS

FIGS. 1-14 are schematic process diagrams of preferred processes incorporating the invention.

### DETAILED DESCRIPTION OF THE INVENTION

The invention relates broadly to wastewater treatment processes and more specifically to such processes which employ activated sludge as a nutrient removal process. The invention can be used with domestic, agricultural and/ or industrial wastewater. Certain types of industrial wastes are difficult to treat biologically because they lack certain nutrients such as nitrogen and phosphorous. In order to biologically treat such wastes, nutrients such as nitrogen and phosphorus may be added to make up for their limited concentration or complete absence. The treatment of paper wastes is an example where available N and P are added for biological activated sludge to maintain ratios of a part N per 20 parts BOD and 1 part P per 75 parts BOD.

It has been found that nitrogen and /or phosphorous removal can be facilitated by a process wherein, with respect to N removal, activated sludge oxidizes ammonia nitrogen to nitrate nitrogen and a first anoxic zone reduces nitrate nitrogen to molecular nitrogen gas. With respect to P removal, volatile acid is supplied to a second anoxic zone to release P into the liquid phase, followed by an aerobic zone to incorporate the P into the biomass from the liquid phase.

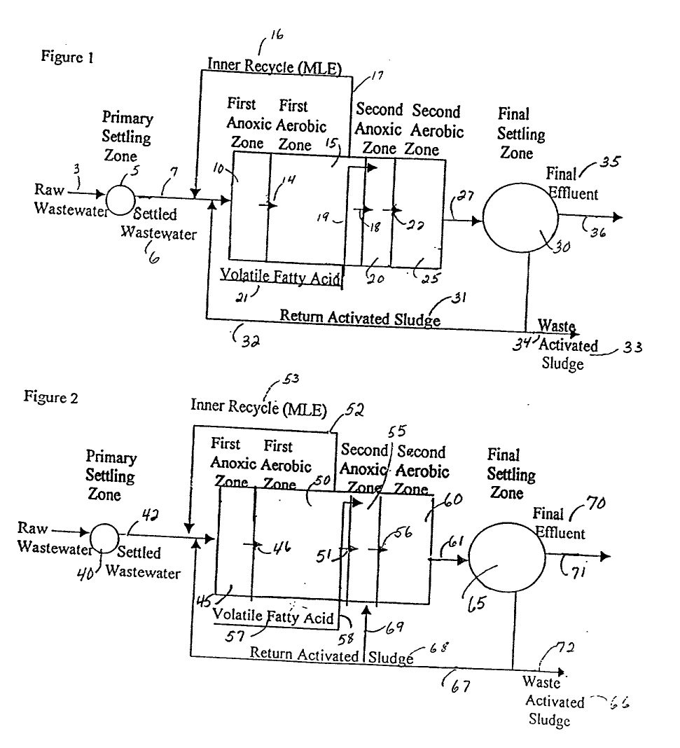

In a preferred embodiment of the process, as depicted in FIG. 1, raw wastewater enters a primary settling zone 5 where some solids are separated from the wastewater. Settled wastewater from the primary settling zone 5 containing suspended solids, BOD, N and P is conveyed to the first anoxic zone 10 via line 7 where the settled wastewater containing suspended solids is mixed with settled sludge from final settling zone 30 va lines 32 and 7. The first anoxic zone effluent is passed via line 14 to a first aerobic zone 15 where the BOD is converted to suspended solids and carbon dioxide and a portion of the ammonia nitrogen is converted to nitrate nitrogen. Nitrate formed in the first and second aerobic zones is reduced to nitrogen gas in the first anoxic zone 10. Nitrogen conversion from ammonia to nitrate is referred to as nitrification. In order for nitrification to occur by microbial oxidation, the BOD must be significantly decreased, such as to a level of 14 mg/l or less. This is because autotrophic bacteria such as the species nitrosommonas and nitrobacter are responsible for the conversion of ammonia nitrogen to nitrate nitrogen. Initially, the activity of the heterotrophic bacteria such as bacillus predominate in the biological oxidation zone 15 as these heterotrophs metabolyze BOD. This heterotrophic activity successfully limits the activity of the nitrifying autotrophs until the BOD has decreased to a sufficiently low level that heterotrophic activity is limited and autotrophic activity can dominate. The same effect, i.e., autotrophic dominance would inherently be achieved with wastewater that started with sufficiently low BOD, such as 14 mg/l or less.

In one embodiment, at the end of the first aerobic zone 15, a portion of the contents from the first aerobic zone 15 in an inner recycle 16 can be recycled back to the first anoxic zone 10 via lines 17 and 7.

The effluent from the first aerobic zone 15 is passed via line 18 to second anoxic zone 20 as is volatile acid 21 via line 19. Bacteria in the presence of the volatile acids and under anoxic conditions, will release phosphate from the sludge to the liquid in the second anoxic zone 20. The effluent from second anoxic zone 20 is passed via 22 to a second aerobic zone 25. In aerobic zone 25, bacteria rapidly take up phosphate in the liquid phase, acting to remove not only the phosphate released in the second anoxic zone 20 but also phosphate content from line 7. Effluent from aerobic zone 25 is passed via line 27 to final settling zone 30. The settled sludge containing suspended solids (return activated sludge 31) is recycled via lines 32 and 7 to the first anoxic zone 10. Excess settled sludge (waste activated sludge 33) is removed from the system via conduit 34. Purified wastewater (final effluent 35) having reduced N, P, BOD, SS and turbidity is passed from the final settling zone 30 via line 36.

As used throughout, the following terms have the following meanings:

By “main aerobic biological zone” is meant any of the known aerobic biological secondary wasterwater treatments such as the activated sludge process and its various modifications. Also included are the fixed film systems as RBC and trickling filter and slurry systems as stabilization ponds, lagoons and ditch oxidation processes. Such aerobic biological oxidation zones include any operation wherein the major thrust is the reduction of BOD by aerobic biological treatment.

By “aerobic conditions” as in the aerobic or aeration zone are meant aeration operating conditions as may be achieved in known process equipment including aerators, mixers and the like. The addition of air or oxygen creates aerobic conditions which means containing a finite amount of dissolved oxygen (DO). Preferred aerobic conditions are those wherein the DO is greater than one mg/l.

By “PENReP Process” is meant a tertiary process designed to follow secondary wastewater systems such as activated sludge, trickling filter or rotating biological contractors (RBC). The first anoxic zone and first aerobic zone represent an activated sludge process in the MLE mode and is a main biological oxidation zone or (MBOZ) which precedes the PENReP Process represented by a second anoxic zone and a second aerobic zone. The actual location of the PENReP Process at the end of the activated sludge aeration tank would depend on the activated sludge design and operating hydraulic retention time (HRT). The HRT of the PENReP Process is independent of the HRT of the activated sludge process.

By “anoxic conditions” are meant conditions in which no DO is present in the bulk liquid but chemical bound oxygen as in nitrate is available for microbial metabolism. Air or oxygen is not usually added.

By “anaerobic conditions” are meant conditions wherein no DO nor nitrate is present in the bulk liquid so that only anaerobic microorganisms can grow. Air or oxygen is not usually added.

By “anoxic/anaerobic conditions” are meant conditions which are at least anoxic (no DO) but there may be or may not be combined oxygen present as nitrate. Air or oxygen is not usually added.

The term “settling” as used herein refers broadly to any solids separation process known in the art, e.g., filtering and centrifuging.

Th e term “volatile acid” as used herein mean s water soluble fatty acids that can be distilled at atmospheric pressure and includes soluble fatty acids of up to 6 carbon atoms. It also includes the water soluble carboxylates of the volatile acids.

The term “methanol” as used herein means a biological oxygen consuming organic such as methyl alcohol (or methanol) which can reduce nitrate-nitrogen to gaseous nitrogen in anoxic systems.

The term “SVI” as used herein is the Sludge Volume Index which represents the settleability of the activated sludge (or any biological sludge) suspended solids. The SVI represents the settling value in ml of the activated sludge in a graduated cylinder for a 30 minute duration that is divided by the suspended solids (as mg/l) in the activated sludge. The resulting number is SVI as mg/l that ranges from about 60 to about 250.

The term “ECP” as used herein is Extracellular Polymer which represents the polymeric material on the exterior of the bacteria in a biological sludge that is an aid in the settling of the biological sludge.

The term “COD” as used herein is Chemical Oxygen Demand which is a chemical oxidation step of wastewater with acid and dichromate to oxidize organic material at high temperature.

The term “SCOD” as used herein is Soluble COD which represents the soluble portion of a wastewater as defined by filtration through a membrane filter with COD of the filtrate.

The type of reactor used in any of the zones described in this invention (aerobic zone, anoxic zone, etc.) might be classified as biological slurry or fixed-film. In addition the two types can be combined as a slurry/fixed-film reactor. An example of the slurry reactor is the aeration tank as used in the activated sludge process. An example of a fixed-film reactor is a trickling filter or a rotating biological contactor (RBC). Combined or hybrid slurry/fixed-film reactors can be of various types such as a slurry system with a stationary or mobile fixed-film. An example of a stationary fixed-film system in an activated sludge aeration tank would be a RBC unit while an example of a mobile fixed-film system would be a mobile media suspended in the activated sludge aeration tank. Other examples are slurry feed to a fixed-film reactor or a settled suspended biological solids feed to a fixed film reactor.

In preferred embodiments of the process of FIG. 1, the wastewater supplied to the first anoxic zone may first be passed through a primary solids separation zone wherein a portion of the BOD and suspended solids is removed. The process conditions within the several zones described in FIG. 1 are set forth in detail above.

In a preferred embodiment of the process, as depicted in FIG. 2, effluent from primary settling zone 40 is passed to a first anoxic zone 45 via line 42 wherein the effluent is mixed with settled sludge (return activated sludge 68) from final settling zone 65 which is returned via lines 67 and 42. The first anoxic zone 45 effluent is passed via line 46 to first aerobic zone 50 where carbon is oxidized to carbon dioxide and biomass and a portion of the ammonia nitrogen are oxidized to nitrate. The effluent from the first aerobic zone 50 is passed via line 51 to the second anoxic zone 55, as is volatile acid 57 via line 58.

In one embodiment, at the end of the first aerobic zone 50, a portion of the contents (inner recycle 53) from the first aerobic zone 50 can be recycled back to the first anoxic zone 50 via lines 52 and 42.

In second anoxic zone 55, bacteria in the presence of the volatile acids and under anoxic conditions will release phosphate from the sludge to the liquid. The effluent from the second anoxic zone 55 is passed via line 56 to a second aerobic zone 60. In aerobic zone 60, bacteria rapidly take up phosphate in the liquid phase, acting to remove not only the phosphate released in the second anoxic zone 55 but also phosphate content from the line 42. Effluent from the second aerobic zone 60 is passed via line 61 to final settling zone 65. Settled sludge (return activated sludge 68) containing suspended solids is recycled both via lines 67 and 42 to the first anoxic zone 45 and also via line 69 to the second anoxic zone 55. Excess settled sludge (waste activated sludge 66) is removed from the system via conduit 72. Purified wastewater (final effluent 70) having reduced N, P, BOD, SS and turbidity is passed from the final settling zone 65 via line 71.

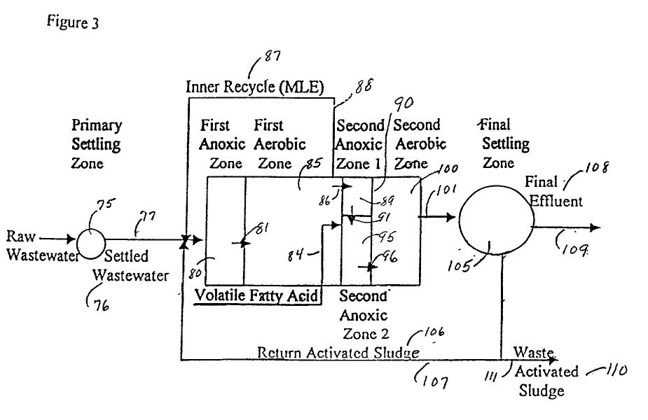

In a preferred embodiment of the process, as depicted in FIG. 3, settled wastewater 76 containing suspended solids, BOD, N and P is conveyed through line 77 to first anoxic zone 80 wherein it is mixed with settled sludge (return activated sludge 106) from final settling zone 105 via line 107. The first anoxic zone 80 effluent is passed via line 81 to first aerobic zone 85 where carbon is oxidized to carbon dioxide and biomass and a portion of the ammonia nitrogen are oxidized to nitrate.

In one embodiment, at the end of the first aerobic zone 85, a portion (inner recycle 87) of the contents from first aerobic zone 85 can be recycled back to the first anoxic zone 80 via lines 87 and 77.

The effluent from the first aerobic zone 85 is passed via line 86 to a first section 89 of second anoxic zone 90. The effluent from first section 89 of the second anoxic zone 90 is passed via line 91 to a second section 95 of the second anoxic zone 90 as is volatile acid 83 via line 84. Bacteria in the presence of the volatile acids and under anoxic conditions will release phosphate from the sludge to the liquid in the second section 95 of the second anoxic zone 90. The effluent from the second section 95 of the second anoxic zone 90 is passed via 96 to second aerobic zone 100. In aerobic zone 100, bacteria rapidly take up the phosphate in the liquid phase, acting to remove not only the phosphate released in the second section of the second anoxic zone 90 but also phosphate content from line 77. Effluent from the second aerobic zone 100 is passed via line 101 to final settling zone 105. Settled sludge (return activated sludge 106) containing suspended solids is recycled via lines 107 and 77 to first anoxic zone 80. Excess settled sludge (waste activated sludge 110) is removed from the system via conduit 111. Purified wastewater (final effluent 108) having reduced N, P, BOD, SS and turbidity is passed from the final settling zone 105 via line 109.

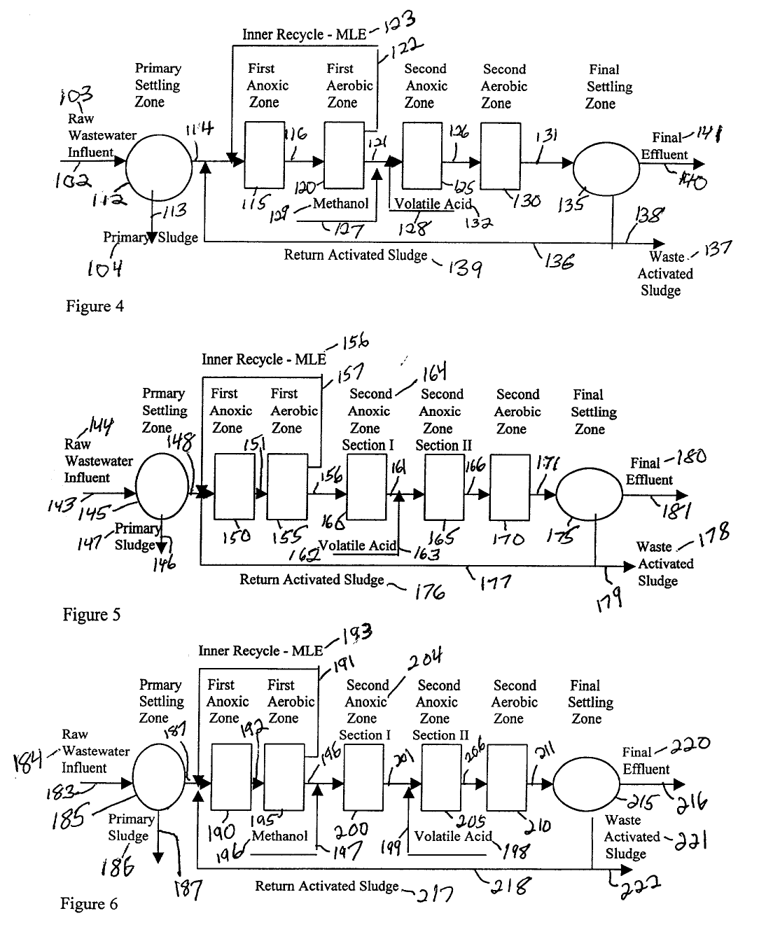

In a preferred embodiment of the process, as depicted in FIG. 4, raw wastewater 103 enters a primary settling tank 112 via line 102 where over half of the solids are separated from the wastewater containing particulate BOD, N and P as a sludge 104 via line 113. Settled effluent from primary settling zone 112 is passed to the first anoxic zone 115 via line 114 wherein the effluent is mixed with settled sludge as return activated sludge 139 from final settling zone 135 which is returned via lines 136 and 114. The first anoxic zone 115 effluent is passed via line 116 to first aerobic zone 120 where carbon is oxidized and biomass and a portion of the ammonia nitrogen is oxidized to nitrate The effluent from the first aerobic zone 120 is passed via line 121 to the second anoxic zone 125 as is volatile acid 132 via line 128 and methanol 129 via line 127.

In one embodiment at the end of the first aerobic zone 120, a portion of the contents as inner recycle 123 from the first aerobic zone 120 can be recycled back to the first anoxic zone 115 via lines 122 and 114.

In second anoxic zone 125, bacteria in the presence of the methanol and volatile acid and under anoxic conditions will reduce nitrate to gaseous nitrogen and release phosphate from the sludge to the liquid. The effluent from the second anoxic zone 125 is passed via line 126 to a second aerobic zone 130. In aerobic zone 130, bacteria rapidly take up phosphate in the liquid phase, acting to remove not only the phosphate released in the second anoxic zone 125 but also the phosphate content from the line 114. Effluent from the second aerobic zone 130 is passed via line 131 to final settling zone 135. Settled sludge as return activated sludge 139 containing suspended solids is recycled both via lines 136 and 114 to the first anoxic zone 115. Excess settled sludge as waste activated sludge 137 is removed from the system via conduit 138. Purified wastewater as final effluent 141 having reduced N, P, BOD, SS and turbidity is passed from the final settling zone 135 via line 140.

In a preferred embodiment of the process, as depicted in FIG. 5, raw wastewater 144 enters a primary settling tank 145 via line 143 where over half of the solids are separated from the wastewater containing particulate BOD, N and P as a sludge 147 via line 146. Settled effluent from primary settling zone 145 containing suspended solids, BOD, N and P is passed to the first anoxic zone 150 via line 148 wherein the effluent is mixed with settled sludge as return activated sludge 176 from final settling zone 175 via line 177. The first anoxic zone 150 effluent is passed via line 151 to first aerobic zone 155 where BOD is converted to suspended solids as biomass and carbon dioxide and a portion of the ammonia nitrogen is oxidized to nitrate.

In one embodiment at the end of the first aerobic zone 155, a portion as inner recycle 156 of the contents from first aerobic zone 155 can be recycled back to the first anoxic zone 150 via lines 157 and 148.

The effluent from the first aerobic zone 155 is passed via line 156 to a first section 160 of second anoxic zone 164. The effluent from first section 160 of the second anoxic zone 164 is passed via line 161 to a second section 165 of the second anoxic zone 164 as is volatile acid 162 via line 163. Bacteria in the presence of the volatile acids and under anoxic conditions will release phosphate from the biomass to the liquid in the second section 165 of the second anoxic zone 164. The effluent from the second section 165 of the second anoxic zone 164 is passed via line 166 to a second aerobic zone 170. In aerobic zone 170 bacteria rapidly take up phosphate in the liquid phase, acting to remove not only the phosphate released in the second section 165 of the second anoxic zone 164 but also phosphate content from line 148. Effluent from the second anoxic zone 164 is passed via line 171 to final settling zone 175. Settled sludge as return activated sludge 176 containing suspended solids is recycled via lines 177 and 148 to first anoxic zone 150. Excess settled sludge as waste activated sludge 178 is removed from the system via conduit 179. Purified wastewater as final effluent 180) having reduced N, P, BOD, SS and turbidity is passed from the final settling zone 175 via line 181.

In a preferred embodiment of the process, as depicted in FIG. 6, raw wastewater 184 enters a primary settling tank 185 via line 183 where over half of the solids are separated from the wastewater containing particulate BOD, N and P as a sludge 186 via line 187. Settled effluent from primary settling zone 185 containing suspended solids, BOD, N and P is passed to the first anoxic zone 190 via line 187 wherein the effluent is mixed with settled sludge as return activated sludge 217 from final settling zone 215 via line 218. The first anoxic zone 190 effluent is passed via line 192 to first aerobic zone 195 where BOD is converted to suspended solids as biomass and carbon dioxide and a portion of the ammonia nitrogen is oxidized to nitrate.

In one embodiment at the end of the first aerobic zone 195, a portion as inner recycle 193 of the contents from first aerobic zone 195 can be recycled back to the first anoxic zone 190 via lines 191 and 187.

The effluent from the first aerobic zone 195 is passed via line 196 to a first section 200 of second anoxic zone 204 as is methanol 196 via line 197 to reduce nitrate into gaseous nitrogen. The effluent from first section 200 of the second anoxic zone 204 is passed via line 201 to a second section 205 of the second anoxic zone 204 as is volatile acid 198 via line 199. Bacteria in the presence of the volatile acids and under anoxic conditions will release phosphate from the biomass to the liquid in the second section 205 of the second anoxic zone 204. The effluent from the second section 205 of the second anoxic zone 204 is passed via line 206 to a second aerobic zone 210. In aerobic zone 210 bacteria rapidly take up phosphate in the liquid phase, acting to remove not only the phosphate released in the second section 205 of the second anoxic zone 204 but also phosphate content from line 187. Effluent from the second aerobic zone 210 is passed via line 211 to final settling zone 215. Settled sludge as return activated sludge 217 containing suspended solids is recycled via lines 218 and 187 to first anoxic zone 190. Excess settled sludge as waste activated sludge 221 is removed from the system via conduit 222. Purified wastewater as final effluent 220 having reduced N, P, BOD, SS and turbidity is passed from the final settling zone 215 via line 216.

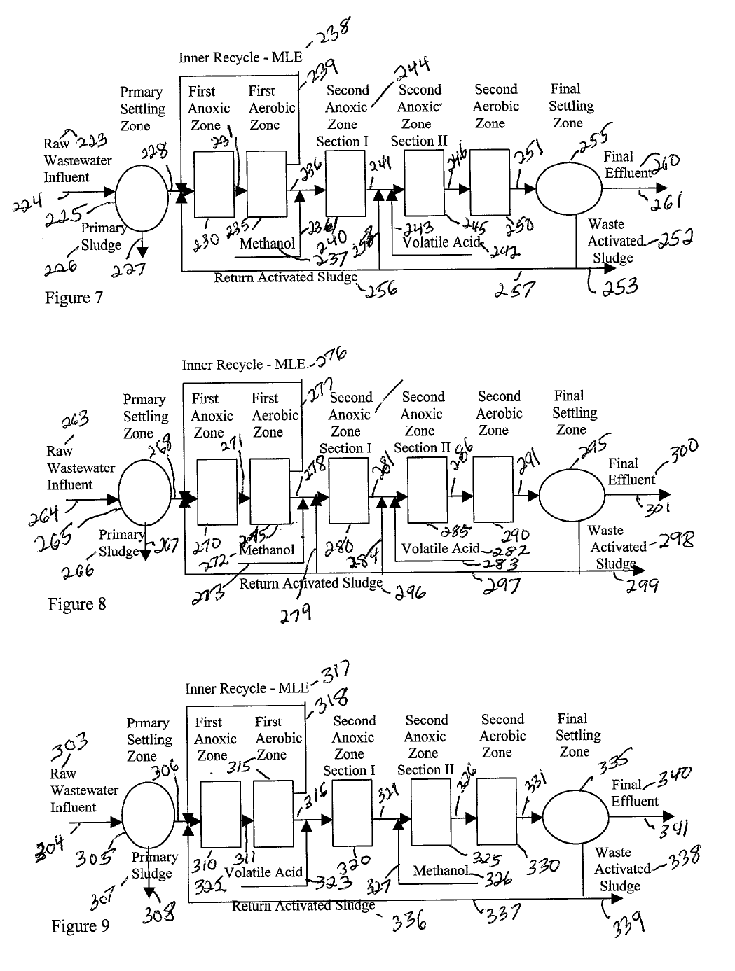

In a preferred embodiment of the process, as depicted in FIG. 7, raw wastewater 223 enters a primary settling tank 225 via line 224 where over half of the solids are separated from the wastewater containing particulate BOD, N and P as a sludge 226 via line 227. Settled effluent from primary settling zone 225 containing suspended solids, BOD, N and P is passed to the first anoxic zone 230 via line 228 wherein the effluent is mixed with settled sludge as return activated sludge 256 from final settling zone 255 via line 257. The first anoxic zone 230 effluent is passed via line 231 to first aerobic zone 235 where BOD is converted to suspended solids as biomass and carbon dioxide and a portion of the ammonia nitrogen is oxidized to nitrate.

In one embodiment at the end of the first aerobic zone 235, a portion as inner recycle 238 of the contents from first aerobic zone 235 can be recycled back to the first anoxic zone 230 via lines 239 and 228.

The effluent from the first aerobic zone 235 is passed via line 236 to a first section 240 of second anoxic zone 204 as is methanol 237 via line 236 to reduce nitrate into gaseous nitrogen. The effluent from first section 240 of the second anoxic zone 204 is passed via line 241 to a second section 245 of the second anoxic zone 204 as is volatile acid 242 via line 243. Bacteria in the presence of the volatile acids and under anoxic conditions will release phosphate from the biomass to the liquid in the second section 245 of the second anoxic zone 204. The effluent from the second section 245 of the second anoxic zone 204 is passed via line 246 to a second aerobic zone 250. In aerobic zone 250 bacteria rapidly take up phosphate in the liquid phase, acting to remove not only the phosphate released in the second section 245 of the second anoxic zone 204 but also phosphate content from line 228. Effluent from the second aerobic zone 250 is passed via line 251 to final settling zone 255. Settled sludge as return activated sludge 256 containing suspended solids is recycled via lines 257 and 228 to first anoxic zone 230 and also via line 258 to the second section 240 of the second anoxic zone. Excess settled sludge as waste activated sludge 252 is removed from the system via conduit 253. Purified wastewater as final effluent 260 having reduced N, P, BOD, SS and turbidity is passed from the final settling zone 255 via line 261.

In a preferred embodiment of the process, as depicted in FIG. 8, raw wastewater 263 enters a primary settling tank 265 via line 264 where over half of the solids are separated from the wastewater containing particulate BOD, N and P as a sludge 266 via line 267. Settled effluent from primary settling zone 265 containing suspended solids, BOD, N and P is passed to the first anoxic zone 270 via line 268 wherein the effluent is mixed with settled sludge as return activated sludge 296 from final settling zone 295 via line 297 and 268. The first anoxic zone 270 effluent is passed via line 271 to first aerobic zone 275 where BOD is converted to suspended solids as biomass and carbon dioxide and a portion of the ammonia nitrogen is oxidized to nitrate. In one embodiment at the end of the first aerobic zone 275, a portion as inner recycle 276 of the contents from first aerobic zone 275 can be recycled back to the first anoxic zone 270 via lines 277 and 268.

The effluent from the first aerobic zone 275 is passed via line 278 to a first section 280 of second anoxic zone 204 as is methanol 272 via line 273 to reduce nitrate into gaseous nitrogen. The effluent from first section 280 of the second anoxic zone 204 is passed via line 281 to a second section 285 of the second anoxic zone 204 as is volatile acid 282 via line 283. Bacteria in the presence of the volatile acids and under anoxic conditions will release phosphate from the biomass to the liquid in the second section 285 of the second anoxic zone 204. The effluent from the second section 285 of the second anoxic zone 204 is passed via line 286 to a second aerobic zone 290. In aerobic zone 290 bacteria rapidly take up phosphate in the liquid phase, acting to remove not only the phosphate released in the second section 285 of the second anoxic zone 204 but also phosphate content from line 268. Effluent from the second aerobic zone 290 is passed via line 291 to final settling zone 295. Settled sludge as return activated sludge 296 containing suspended solids is recycled via lines 297 and 268 to first anoxic zone 270 and also via line 279 to the first section 280 of the second anoxic zone and also via line 284 to the second section 285 of the second anoxic zone. Excess settled sludge as waste activated sludge 298 is removed from the system via conduit 299. Purified wastewater as final effluent 300 having reduced N, P, BOD, SS and turbidity is passed from the final settling zone 295 via line 301.

In a preferred embodiment of the process, as depicted in FIG. 9, raw wastewater 303 enters a primary settling tank 305 via line 304 where over half of the solids are separated from the wastewater containing particulate BOD, N and P as a sludge 307 via line 308. Settled effluent from primary settling zone 305 containing suspended solids, BOD, N and P is passed to the first anoxic zone 310 via line 306 wherein the effluent is mixed with settled sludge as return activated sludge 336 from final settling zone 325 via line 337. The first anoxic zone 310 effluent is passed via line 311 to first aerobic zone 315 where BOD is converted to suspended solids as biomass and carbon dioxide and a portion of the ammonia nitrogen is oxidized to nitrate.

In one embodiment at the end of the first aerobic zone 315, a portion as inner recycle 317 of the contents from first aerobic zone 315 can be recycled back to the first anoxic zone 310 via lines 318 and 306.

The effluent from the first aerobic zone 315 is passed via line 316 to a first section 320 of second anoxic zone 204 as is volatile acid 322 via line 323. Bacteria in the presence of the volatile acids and under anoxic conditions will release phosphate from the biomass to the liquid in the first section 320. The effluent from first section 320 of the second anoxic zone 204 is passed via line 321 to a second section 325 of the second anoxic zone 204 as is methanol 326 via line 327 to reduce nitrate into gaseous nitrogen. The effluent from the second section 325 of the second anoxic zone 204 is passed via line 326 to a second aerobic zone 330. In aerobic zone 330 bacteria rapidly take up phosphate in the liquid phase, acting to remove not only the phosphate released in the first section 320 of the second anoxic zone 204 but also phosphate content from line 306. Effluent from the second aerobic zone 330 is passed via line 331 to final settling zone 335. Settled sludge as return activated sludge 336 containing suspended solids is recycled via lines 337 and 306 to first anoxic zone 310. Excess settled sludge as waste activated sludge 338 is removed from the system via conduit 339. Purified wastewater as final effluent 340 having reduced N, P, BOD, SS and turbidity is passed from the final settling zone 335 via line 341.

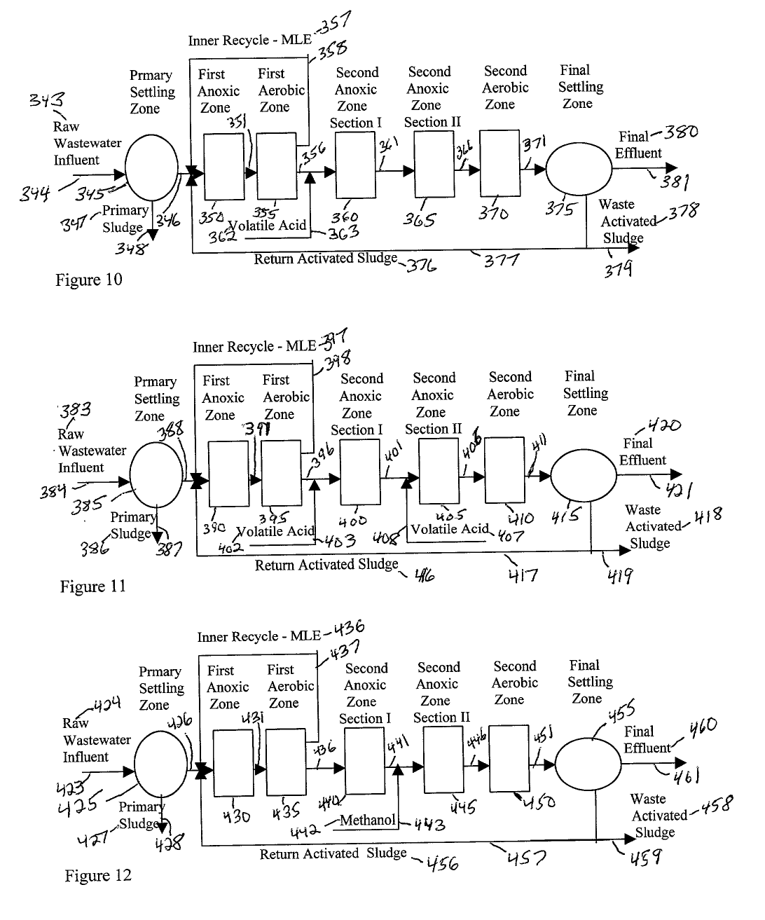

In a preferred embodiment of the process, as depicted in FIG. 10, raw wastewater 343 enters a primary settling tank 345 via line 344 where over half of the solids are separated from the wastewater containing particulate BOD, N and P as a sludge 347 via line 348. Settled effluent from primary settling zone 345 containing suspended solids, BOD, N and P is passed to the first anoxic zone 350 via line 346 wherein the effluent is mixed with settled sludge as return activated sludge 376 from final settling zone 375 via line 377 and 346. The first anoxic zone 350 effluent is passed via line 351 to first aerobic zone 355 where BOD is converted to suspended solids as biomass and carbon dioxide and a portion of the ammonia nitrogen is oxidized to nitrate.

In one embodiment at the end of the first aerobic zone 355, a portion as inner recycle 357 of the contents from first aerobic zone 355 can be recycled back to the first anoxic zone 350 via lines 358 and 346.

The effluent from the first aerobic zone 355 is passed via line 356 to a first section 360 of second anoxic zone 204 as is volatile acid 362 via line 363. Bacteria in the presence of the volatile acids and under anoxic conditions will release phosphate from the biomass to the liquid in the first section 360 of the second anoxic zone. The effluent from first section 360 of the second anoxic zone 204 is passed via line 361 to a second section 365 of the second anoxic zone 204. The effluent from the second section 365 of the second anoxic zone 204 is passed via line 366 to a second aerobic zone 370. In aerobic zone 330 bacteria rapidly take up phosphate in the liquid phase, acting to remove not only the phosphate released in the first section 360 of the second anoxic zone 204 but also phosphate content from line 346. Effluent from the second aerobic zone 370 is passed via line 371 to final settling zone 375. Settled sludge as return activated sludge 376 containing suspended solids is recycled via lines 377 and 346 to first anoxic zone 350. Excess settled sludge as waste activated sludge 378 is removed from the system via conduit 379. Purified wastewater as final effluent 380 having reduced N, P, BOD, SS and turbidity is passed from the final settling zone 375 via line 381.

In a preferred embodiment of the process, as depicted in FIG. 11, raw wastewater 383 enters a primary settling tank 385 via line 384 where over half of the solids are separated from the wastewater containing particulate BOD, N and P as a sludge 386 via line 387. Settled effluent from primary settling zone 385 containing suspended solids, BOD, N and P is passed to the first anoxic zone 390 via line 388 wherein the effluent is mixed with settled sludge as return activated sludge 416 from final settling zone 415 via line 417. The first anoxic zone 390 effluent is passed via line 391 to first aerobic zone 395 where BOD is converted to suspended solids as biomass and carbon dioxide and a portion of the ammonia nitrogen is oxidized to nitrate.

In one embodiment at the end of the first aerobic zone 395, a portion as inner recycle 397 of the contents from first aerobic zone 395 can be recycled back to the first anoxic zone 390 via lines 398 and 388.

The effluent from the first aerobic zone 395 is passed via line 396 to a first section 400 of second anoxic zone 204 as is volatile acid 402 via line 403. Bacteria in the presence of the volatile acids and under anoxic conditions will release phosphate from the biomass to the liquid in the first section 400 of the second anoxic zone. The effluent from first section 400 of the second anoxic zone 204 is passed via line 401 to a second section 405 of the second anoxic zone 204 as volatile acid 407 via line 408 to further release phosphate from the biomass to the liquid in the second section 405 of the second anoxic zone. The extra volatile acid is needed in the second section 405 when the nitrate level in first section 400 is very high since the volatile acid will reduce the nitrate preferentially over the phosphate release. The effluent from the second section 405 of the second anoxic zone 204 is passed via line 406 to a second aerobic zone 410. In aerobic zone 410 bacteria rapidly take up phosphate in the liquid phase, acting to remove not only the phosphate released in the first section 400 of the second anoxic zone 204 but also phosphate content from line 388. Effluent from the second aerobic zone 410 is passed via line 411 to final settling zone 415. Settled sludge as return activated sludge 416 containing suspended solids is recycled via lines 417 and 388 to first anoxic zone 390. Excess settled sludge as waste activated sludge 418 is removed from the system via conduit 419. Purified wastewater as final effluent 420 having reduced N, P, BOD, SS and turbidity is passed from the final settling zone 415 via line 421.

In a preferred embodiment of the process, as depicted in FIG. 12, raw wastewater 424 enters a primary settling tank 425 via line 423 where over half of the solids are separated from the wastewater containing particulate BOD, N and P as a sludge 427 via line 428. Settled effluent from primary settling zone 425 containing suspended solids, BOD, N and P is passed to the first anoxic zone 430 via line 426 wherein the effluent is mixed with settled sludge as return activated sludge 456 from final settling zone 455 via line 457. The first anoxic zone 430 effluent is passed via line 431 to first aerobic zone 435 where BOD is converted to suspended solids as biomass and carbon dioxide and a portion of the ammonia nitrogen is oxidized to nitrate.

In one embodiment at the end of the first aerobic zone 435, a portion as inner recycle 436 of the contents from first aerobic zone 435 can be recycled back to the first anoxic zone 430 via lines 437 and 426.

The effluent from the first aerobic zone 435 is passed via line 436 to a first section 440 of second anoxic zone 204. The effluent from first section 400 of the second anoxic zone 204 is passed via line 441 to a second section 445 of the second anoxic zone 204 as is methanol 442 via line 443 wherein nitrate will be reduced. The effluent from the second section 445 of the second anoxic zone 204 is passed via line 446 to a second aerobic zone 450. Effluent from the second aerobic zone 450 is passed via line 451 to final settling zone 455. Settled sludge as return activated sludge 456 containing suspended solids is recycled via lines 457 and 426 to first anoxic zone 430. Excess settled sludge as waste activated sludge 458 is removed from the system via conduit 459. Purified wastewater as final effluent 460 having reduced N, P, BOD, SS and turbidity is passed from the final settling zone 455 via line 461.

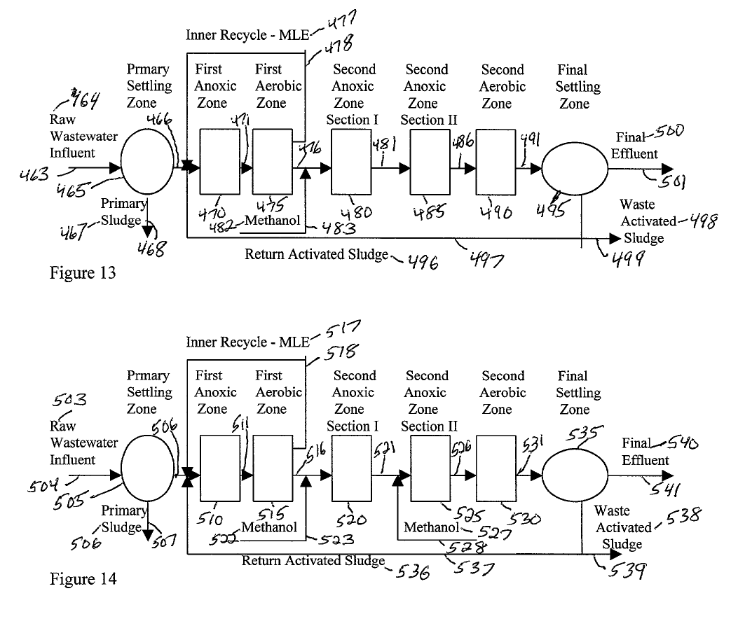

In a preferred embodiment of the process, as depicted in FIG. 13, raw wastewater 464 enters a primary settling tank 465 via line 463 where over half of the solids are separated from the wastewater containing particulate BOD, N and P as a sludge 467 via line 468. Settled effluent from primary settling zone 465 containing suspended solids, BOD, N and P is passed to the first anoxic zone 470 via line 466 wherein the effluent is mixed with settled sludge as return activated sludge 496 from final settling zone 495 via line 497. The first anoxic zone 470 effluent is passed via line 471 to first aerobic zone 475 where BOD is converted to suspended solids as biomass and carbon dioxide and a portion of the ammonia nitrogen is oxidized to nitrate.

In one embodiment at the end of the first aerobic zone 475, a portion as inner recycle 477 of the contents from first aerobic zone 475 can be recycled back to the first anoxic zone 470 via lines 478 and 466.

The effluent from the first aerobic zone 475 is passed via line 476 to a first section 480 of second anoxic zone 204 as is methanol 482 via line 483 wherein nitrate will be reduced. The effluent from first section 480 of the second anoxic zone 204 is passed via line 481 to a second section 485 of the second anoxic zone 204 The effluent from the second section 485 of the second anoxic zone 204 is passed via line 486 to a second aerobic zone 490. Effluent from the second aerobic zone 490 is passed via line 491 to final settling zone 495. Settled sludge as return activated sludge 496 containing suspended solids is recycled via lines 497 and 466 to first anoxic zone 470. Excess settled sludge as waste activated sludge 498 is removed from the system via conduit 499. Purified wastewater as final effluent 500 having reduced N, P, BOD, SS and turbidity is passed from the final settling zone 495 via line 501.

In a preferred embodiment of the process, as depicted in FIG. 14, raw wastewater 503 enters a primary settling tank 505 via line 504 where over half of the solids are separated from the wastewater containing particulate BOD, N and P as a sludge 506 via line 507. Settled effluent from primary settling zone 505 containing suspended solids, BOD, N and P is passed to the first anoxic zone 510 via line 506 wherein the effluent is mixed with settled sludge as return activated sludge 536 from final settling zone 535 via line 537. The first anoxic zone 510 effluent is passed via line 511 to first aerobic zone 515 where BOD is converted to suspended solids as biomass and carbon dioxide and a portion of the ammonia nitrogen is oxidized to nitrate.

In one embodiment at the end of the first aerobic zone 515, a portion as inner recycle 517 of the contents from first aerobic zone 515 can be recycled back to the first anoxic zone 510 via lines 518 and 506.

The effluent from the first aerobic zone 515 is passed via line 516 to a first section 520 of second anoxic zone 204 as is methanol 522 via line 523 wherein nitrate will be reduced. The effluent from first section 520 of the second anoxic zone 204 is passed via line 521 to a second section 525 of the second anoxic zone 204 as is methanol 527 via line 528 wherein nitrate will be further reduced. The effluent from the second section 525 of the second anoxic zone 204 is passed via line 526 to a second aerobic zone 530. Effluent from the second aerobic zone 530 is passed via line 531 to final settling zone 535. Settled sludge as return activated sludge 536 containing suspended solids is recycled via lines 537 and 506 to first anoxic zone 510. Excess settled sludge as waste activated sludge 538 is removed from the system via conduit 539. Purified wastewater as final effluent 540 having reduced N, P, BOD, SS and turbidity is passed from the final settling zone 535 via line 541.

### EXAMPLE

An embodiment of the process of FIG. 1 according to the invention will be termed PENReP (including activated sludge MLE-type inner recycle). The process was tested in the field with primary settled wastewater from the Rockland County, NY, (Sewer District No. 1) wastewater treatment plant in Orangeburg, N.Y., USA. The test data covered the period from Sept. 15, 1999 to Jan. 11, 2000. The operating conditions for the test period are shown in TABLE 1 and the test results are shown in TABLE 2.

TABLE 1

| | | | | Acetic | |
|---|---|---|---|---|---|
| | | | | acid | |
| Run No. | Flow (Gpm) | HRT (hours) | SRT (days) | (mg/l) | Qr/Q |
| 1 | 2.5 | 8 | 10 | 50 | 1 |
| 2 | 4 | 5 | 5 | 50 | 1 |
| 3 | 4 | 5 | 5 | 50 | 0.5 |

TABLE 2

| | Total | | | | |
|---|---|---|---|---|---|
| | Inorganic | | | | Absorbance |
| | Nitrogen, | o-PO₄ | SS | Soluble | (355 nm) |
| Process Stream | mg/l | as P, mg/l | mg/l | COD mg/l | units |
| Run 1 | | | | | |
| Settled Primary | 32.64 | 2.98 | 75 | 113 | — |
| Effluent | | | | | |
| PENReP | 1.15 | 0.05 | 5.2 | 20 | 0.049 |
| Effluent | | | | | |
| Run 2 | | | | | |
| Settled Primary | 41.98 | 3.21 | 69 | 96 | — |
| Effluent | | | | | |
| PENReP | 1.5 | 0.11 | 2.5 | 18 | 0.041 |
| Run 3 | | | | | |
| Settled Primary | 45.11 | 3.3 | 74 | 130 | — |
| Effluent | | | | | |
| PENReP | 1.52 | 0.08 | 3 | 19 | 0.046 |

HRT is hydraulic retention time

SRT is solids retention time

Qr/Q is the total recycle of the final settled solids divided by the total flow

SS is suspended solids

COD is chemical oxygen demand

The testing of the Activated Sludge-single sludge PENReP Process (SSPP) is shown above in Runs 1, 2 and 3. The removals are based on a settled wastewater as the feed.

Run 1 with a hydraulic retention time (HRT) of 8 hours and a solids retention time (SRT) of 10 days shows excellent TIN (Total Inorganic Nitrogen) (ammonia, nitrite and nitrate nitrogen) removal of 96.48%, excellent o-PO4 (ortho-phosphate) removal of 98.32%, excellent SS (suspended solids) removal of 93.06% and excellent SCOD (soluble chemical oxygen demand) removal of 82.3%. Run 2 reduced the HRT to 5 hours and the SRT to 5 days and still showed excellent results. The TIN was reduced by 96.43% and the o-PO4 was reduced by 96.57%, the SS was reduced by 96.38% and the SCOD was reduced by 81.25%. Run 3 kept the same HRT and SRT as Run 2 but reduced the cycle ratio (Total recycle of the final settled solids divided by total flow) to 0.5. The results were still excellent. The TIN was reduced by 96.63%, the o-P04 was reduced by 97.58%, the SS was reduced by 95.95% and the SCOD was reduced by 85.38%.

Absorbance at 355 nm in Runs 1, 2 and 3 was measured against tap water and represents the relative absorption or the clarity of the effluent produced by the process. The effluent could be described in words such as “water white”. The effluent can also be better described with numbers. The effluent absorbance divided by the tap water absorbance was 3.88 for Run 1, 3.41 for Run 2, and 3.42 for Run 3.

We claim:

1. A wastewater treatment process providing nitrogen, phosphorus, biochemical oxygen demand (BOD) and suspended solids removal comprising:
(a) passing wastewater containing ammonia nitrogen, phosphate, BOD and suspended solids to a first anoxic zone therein reducing nitrate in a recycled stream from (f);
(b) passing the effluent of the first anoxic zone to a first aerobic zone where at least a portion of the BOD is oxidized and at least a portion of the ammonia nitrogen is oxidized to nitrate nitrogen;
(c) passing the effluent of the first aerobic zone and volatile fatty acid to a second anoxic zone where phosphorus is released into a liquid wastewater phase;
(d) passing the effluent from the second anoxic zone including the volatile fatty acid to a second aerobic zone where phosphorus is absorbed into the biomass and ammonia nitrogen is partially removed and partially oxidized;
(e) passing the effluent from the second aerobic zone to a final settling zone therein separating
(i) a purified wastewater having a decreased nitrogen, phosphorus, BOD and suspended solids, and
(ii) a sludge containing suspended solids, phosphate and BOD;
(f) recycling at least a portion of the sludge (ii) to the zone of (a).

2. The wastewater treatment process according to claim 1 further comprising recycling a portion of the contents at the end of the first aerobic zone (b) back to the first anoxic zone of (a).

3. The wastewater treatment process according to claim 1 further comprising passing the wastewater containing ammonia nitrogen, phosphate, BOD, and suspended solids though a primary solids separation zone where a portion of the BOD and suspended solids is removed before passing the wastewater to the first anoxic zone (a).

4. The wastewater treatment process according to claim 1 wherein the volatile fatty acid is a soluble fatty acid of C₁₋₆ or water soluble carboxylate thereof.

5. The wastewater treatment process according to claim 1 further comprising recycling a portion of the settled sludge(ii) of the final settling zone (e) back to the second anoxic zone of (c).

6. A wastewater treatment process providing nitrogen, phosphorus, biochemical oxygen demand (BOD) and suspended solids removal comprising:
(a) passing wastewater containing ammonia nitrogen, phosphate, BOD and suspended solids to a first anoxic zone therein reducing at least some nitrate in a recycled stream from (f);
(b) passing the effluent of the first anoxic zone to a first aerobic zone where at least some of the BOD is oxidized and at least some of the ammonia nitrogen is oxidized to nitrate nitrogen;
(c) passing methyl alcohol and the effluent of the first aerobic zone to the second anoxic zone where a portion of the nitrate is reduced;
(d) passing the effluent from the second anoxic zone to the second aerobic zone;
(e) passing the effluent from the second aerobic zone to a final settling zone therein separating
(i) a purified wastewater having a decreased nitrogen, BOD and suspended solids, and
(ii) a sludge containing suspended solids, and BOD; and
(f) recycling at least a portion of the sludge (ii) to the first anoxic zone of (a).

7. The wastewater treatment process according to claim 6 further comprising recycling a portion of the contents at the end of the first aerobic zone (b) back to the first anoxic zone of (a).

8. The wastewater treatment process according to claim 6 further comprising passing the wastewater containing ammonia nitrogen, phosphate, BOD, and suspended solids though a primary solids separation zone where a portion of the BOD and suspended solids is removed before passing the wastewater to the first anoxic zone (a).

9. The wastewater treatment process according to claim 6 wherein the volatile fatty acid is a soluble fatty acid of C₁₋₆ or water soluble carboxylate thereof.

10. The wastewater treatment process according to claim 6 further comprising recycling a portion of the settled sludge (ii) of the final settling zone (e) back to the second anoxic zone of (c).

11. A wastewater treatment process providing nitrogen, phosphorus, biochemical oxygen demand (BOD) and suspended solids removal comprising:
(a) passing wastewater containing ammonia nitrogen, phosphate, BOD and suspended solids to a first anoxic zone therein reducing nitrate in a recycled stream from (f);
(b) passing the effluent of the first anoxic zone to a first aerobic zone where at least a portion of the BOD is oxidized and at least a portion of the ammonia nitrogen is oxidized to nitrate nitrogen;
(c) passing the effluent of the first aerobic zone, methyl alcohol and volatile fatty acid to a second anoxic zone where a portion of the nitrate is reduced and phosphorus is released into a liquid wastewater phase;
(d) passing the effluent from the second anoxic zone including the volatile fatty acid to a second aerobic zone where phosphorus is absorbed into the biomass and ammonia nitrogen is partially removed and partially oxidized;
(e) passing the effluent from the second aerobic zone to a final settling zone therein separating
(j) a purified wastewater having a decreased nitrogen, phosphorus, BOD and suspended solids, and
(ii) a sludge containing suspended solids, phosphate and BOD;
(f) recycling at least a portion of the sludge (ii) to the zone of (a).

12. The wastewater treatment process according to claim 11 further comprising recycling a portion of the contents at the end of the first aerobic zone (b) back to the first anoxic zone of (a).

13. The wastewater treatment process according to claim 11 further comprising passing the wastewater containing ammonia nitrogen, phosphate, BOD, and suspended solids though a primary solids separation zone where a portion of the BOD and suspended solids is removed before passing the wastewater to the first anoxic zone (a).

14. The wastewater treatment process according to claim 11 wherein the volatile fatty acid is a soluble fatty acid of C₁₋₆ or water soluble carboxylate thereof.

15. The wastewater treatment process according to claim 11 further comprising recycling a portion of the settled sludge (ii) of the final settling zone (e) back to the second anoxic zone of (c).

16. A wastewater treatment process providing nitrogen, phosphorus, biochemical oxygen demand (BOD) and suspended solids removal comprising:
(a) passing wastewater containing ammonia nitrogen, phosphate, BOD and suspended solids to a first anoxic zone therein reducing at least some nitrate in a recycled stream from (g);
(b) passing the effluent of the first anoxic zone to a first aerobic zone where at least some of the BOD is oxidized and at least some of the ammonia nitrogen is oxidized to nitrate nitrogen;
(c) passing the effluent of the first aerobic zone to a first section (I) of a second anoxic zone where anoxic conditions are established after the aerobic zone in (b);
(d) passing volatile fatty acid and the effluent of a first section (I) of a second anoxic zone to a second section (II) of a second anoxic zone where phosphorus is released into a liquid wastewater phase;
(e) passing the effluent from the second section (II) of the second anoxic zone including the volatile acid to a second aerobic zone where phosphorus is absorbed into the biomass and at least some of the ammonia nitrogen is partially removed and partially oxidized;
(f) passing the effluent from the second aerobic zone to a final settling zone therein separating
(i) a purified wastewater having a decreased nitrogen, phosphorus, BOD and suspended solids, and
(ii) a sludge containing suspended solids, phosphate and BOD; and
(g) recycling at least a portion of the sludge (ii) to the first anoxic zone of (a).

17. The wastewater treatment process according to claim 16 further comprising recycling a portion of the contents at the end of the first aerobic zone (b) back to the first anoxic zone of (a).

18. The wastewater treatment process according to claim 16 further comprising passing the wastewater containing ammonia nitrogen, phosphate, BOD, and suspended solids though a primary solids separation zone where a portion of the BOD and suspended solids is removed before passing the wastewater to the first anoxic zone (a).

19. The wastewater treatment process according to claim 16 wherein the volatile fatty acid is a soluble fatty acid of C₁₋₆ or water soluble carboxylate thereof.

20. The wastewater treatment process according to claim 16 further comprising recycling a portion of the settled sludge (ii) of the final settling zone (f) back to acid the first anoxic section (I) of the second anoxic zone of (c).

21. The wastewater treatment process according to claim 16 further comprising recycling a portion of the settled sludge (ii) of the final settling zone (f) back to the second section (II) of the second anoxic zone of (d).

22. The wastewater treatment process according to claim 16 further comprising recycling a portion of the settled sludge (ii) of the final settling zone (f) back to the first anoxic section (I) of the second anoxic zone of (c) and a portion back to the second section (II) of the second anoxic zone of (d).

23. A wastewater treatment process providing nitrogen, phosphorus, biochemical oxygen demand (BOD) and suspended solids removal comprising:
(a) passing wastewater containing ammonia nitrogen, phosphate, BOD and suspended solids to a first anoxic zone therein reducing at least some nitrate in a recycled stream from (g);
(b) passing the effluent of the first anoxic zone to a first aerobic zone where at least some of the BOD is oxidized and at least some of the ammonia nitrogen is oxidized to nitrate nitrogen;
(c) passing the effluent of the first aerobic zone and methyl alcohol to a first section (I) of a second anoxic zone to reduce the nitrate;
(d) passing a volatile fatty acid and the effluent of a first section (I) of a second anoxic zone to a second section (II) of a second anoxic zone where phosphorus is released into a liquid wastewater phase;
(e) passing the effluent from the second section (II) of a second anoxic zone including the volatile acid to a second aerobic zone where phosphorus is absorbed into the biomass and at least some of the ammonia nitrogen is partially removed and partially oxidized;
(f) passing the effluent from the second aerobic zone to a final settling zone therein separating
(i) a purified wastewater having a decreased nitrogen, phosphorus, BOD and suspended solids, and
(ii) a sludge containing suspended solids, phosphate and BOD; and
(g) recycling at least a portion of the sludge (ii) to the first anoxic zone of (a).

24. The wastewater treatment process according to claim 23 further comprising recycling a portion of the contents at the end of the first aerobic zone (b) back to the first anoxic zone of (a).

25. The wastewater treatment process according to claim 23 further comprising passing the wastewater containing ammonia nitrogen, phosphate, BOD, and suspended solids though a primary solids separation zone where a portion of the BOD and suspended solids is removed before passing the wastewater to the first anoxic zone (a).

26. The wastewater treatment process according to claim 23 wherein the volatile fatty acid is a soluble fatty acid of C₁₋₆ or water soluble carboxylate thereof.

27. The wastewater treatment process according to claim 23 further comprising recycling a portion of the settled sludge (ii) of the final settling zone (f) back to the first anoxic section (I) of the second anoxic zone of (c).

28. The wastewater treatment process according to claim 23 further comprising recycling a portion of the settled sludge (ii) of the final settling zone (f) back the second section (II) of the second anoxic zone of (d).

29. The wastewater treatment process according to claim 23 further comprising recycling a portion of the settled sludge (ii) of the final settling zone (f) back to the first anoxic section (I) of the second anoxic zone of (c) and a portion back to the second section (II) of the second anoxic zone of (d).

30. A wastewater treatment process providing nitrogen, phosphorus, biochemical oxygen demand (BOD) and suspended solids removal comprising:
(a) passing wastewater containing ammonia nitrogen, phosphate, BOD and suspended solids to a first anoxic zone therein reducing at least some nitrate in a recycled stream from (g);
(b) passing the effluent of the first anoxic zone to a first aerobic zone where at least some of the BOD is oxidized and at least some of the ammonia nitrogen is oxidized to nitrate nitrogen;
(c) passing the effluent of the first aerobic zone to a first section (I) of a second anoxic zone where anoxic conditions are established after the aerobic zone in (b);
(d) passing volatile fatty acid and the effluent from a first anoxic section (I) of a second anoxic zone to a second section (II) of a second anoxic zone and a portion of the phosphorus is released into a liquid wastewater phase;
(e) passing the effluent from a second section (II) of a second anoxic zone including the volatile acid to a second aerobic zone where phosphorus is absorbed into the biomass and at least some of the ammonia nitrogen is partially removed and partially oxidized;
(f) passing the effluent from a second aerobic zone to a final settling zone therein separating
(i) a purified wastewater having a decreased nitrogen, phosphorus, BOD and suspended solids, and
(ii) a sludge containing suspended solids, phosphate and BOD; and
(g) recycling at least a portion of the sludge (ii) to the first anoxic zone of (a).

31. The wastewater treatment process according to claim 30 further comprising recycling a portion of the contents at the end of the first aerobic zone (b) back to the first anoxic zone of (a).

32. The wastewater treatment process according to claim 30 further comprising passing the wastewater containing ammonia nitrogen, phosphate, BOD, and suspended solids though a primary solids separation zone where a portion of the BOD and suspended solids is removed before passing the wastewater to the first anoxic zone (a).

33. The wastewater treatment process according to claim 30 wherein the volatile fatty acid is a soluble fatty acid of C₁₋₆ or water soluble carboxylate thereof.

34. The wastewater treatment process according to claim 30 further comprising adding acetic acid to a first anoxic section (I) of a second anoxic zone.

35. A wastewater treatment process providing nitrogen, phosphorus, biochemical oxygen demand (BOD) and suspended solids removal comprising:
(a) passing wastewater containing ammonia nitrogen, phosphate, BOD and suspended solids to a first anoxic zone therein reducing at least some nitrate in a recycled stream from (g);
(b) passing the effluent of the first anoxic zone to a first aerobic zone where a portion of the BOD is oxidized and a portion of the ammonia nitrogen is oxidized to nitrate nitrogen;
(c) passing acetic acid and the effluent of the first aerobic zone to a first anoxic section (I) of a second anoxic zone where a portion of the nitrate is reduced and phosphorus is passed into a liquid wastewater phase;
(d) passing methyl alcohol and effluent from the first anoxic section (I) of the second anoxic zone to the second anoxic section (II) of the second anoxic zone;
(e) passing the effluent from the second anoxic section (II) of the second anoxic zone to a second aerobic zone where phosphorus is absorbed into the biomass and at least some of the ammonia nitrogen is partially removed and partially oxidized
(f) passing the effluent from the second aerobic zone to a final settling zone therein separating
(i) a purified wastewater having a decreased nitrogen, phosphorus, BOD and suspended solids, and
(ii) a sludge containing suspended solids, phosphate and BOD; and
(g) recycling at least a portion of the sludge (ii) to the first anoxic zone of (a).

36. The wastewater treatment process according to claim 35 further comprising recycling a portion of the contents at the end of the first aerobic zone (b) back to the first anoxic zone of (a).

37. The wastewater treatment process according to claim 35 further comprising passing the wastewater containing ammonia nitrogen, phosphate, BOD, and suspended solids though a primary solids separation zone where a portion of the BOD and suspended solids is removed before passing the wastewater to the first anoxic zone (a).

38. The wastewater treatment process according to claim 35 wherein the volatile fatty acid is a soluble fatty acid of C₁₋₆ or water soluble carboxylate thereof.

39. A wastewater treatment process providing nitrogen, phosphorus, biochemical oxygen demand (BOD) and suspended solids removal comprising:
(a) passing wastewater containing ammonia nitrogen, phosphate, BOD and suspended solids to a first anoxic zone therein reducing at least some nitrate in a recycled stream from (g);
(b) passing the effluent of the first anoxic zone to a first aerobic zone where a portion of the BOD is oxidized and a portion of the ammonia nitrogen is oxidized to nitrate nitrogen;
(c) passing the effluent of the first aerobic zone to a first anoxic section (I) of a second anoxic zone where anoxic conditions are established after the aerobic zone in (b);
(d) passing methyl alcohol and effluent from the first anoxic section (I) of the second anoxic zone to the second anoxic section (II) of the second anoxic zone where a portion of the nitrate is reduced;
(e) passing the effluent from the second anoxic section (II) of the second anoxic zone to a second aerobic zone;
(f) passing the effluent from the second aerobic zone to a final settling zone therein separating
(i) a purified wastewater having a decreased nitrogen, BOD and suspended solids, and
(ii) a sludge containing suspended solids, and BOD; and
(g) recycling at least a portion of the sludge (ii) to the first anoxic zone of (a).

40. The wastewater treatment process according to claim 39 further comprising recycling a portion of the contents at the end of the first aerobic zone (b) back to the first anoxic zone of (a).

41. The wastewater treatment process according to claim 39 further comprising passing the wastewater containing ammonia nitrogen, phosphate, BOD, and suspended solids though a primary solids separation zone where a portion of the BOD and suspended solids is removed before passing the wastewater to the first anoxic zone (a).

42. The wastewater treatment process according to claim 39 wherein the volatile fatty acid is a soluble fatty acid of C₁₋₆ or water soluble carboxylate thereof.

43. The wastewater treatment process according to claim 39 further comprising adding methyl alcohol to a first anoxic section (I) of a second anoxic zone.

44. A wastewater treatment process providing nitrogen, biochemical oxygen demand (BOD) and suspended solids removal comprising:
a. passing wastewater containing ammonia nitrogen, phosphate, BOD and suspended solids to a first anoxic zone therein reducing at least some nitrate in a recycled stream from (g);
b. passing the effluent of the first anoxic zone to a first aerobic zone where at least some of the BOD is oxidized and at least some of the ammonia nitrogen is oxidized to nitrate nitrogen;
c. passing the effluent of the first aerobic zone and methyl alcohol to a first section (I) of a second anoxic zone to reduce a portion of the nitrate;
d. passing the effluent of a first section (I) of a second anoxic zone to a second section (II) of a second anoxic zone to further reduce a portion of the nitrate;
e. passing the effluent from the second section (II) of a second anoxic zone to a second aerobic zone;
f. passing the effluent from the second aerobic zone to a final settling zone therein separating
(j) a purified wastewater having a decreased nitrogen, BOD and suspended solids, and
(ii) a sludge containing suspended solids, and BOD; and
g. recycling at least a portion of the sludge (ii) to the first anoxic zone of (a).

45. The wastewater treatment process according to claim 44 further comprising recycling a portion of the contents at the end of the first aerobic zone (b) back to the first anoxic zone of (a).

46. The wastewater treatment process according to claim 44 further comprising passing the wastewater containing ammonia nitrogen, phosphate, BOD, and suspended solids though a primary solids separation zone where a portion of the BOD and suspended solids is removed before passing the wastewater to the first anoxic zone (a).

47. The wastewater treatment process according to claim 44 wherein the volatile fatty acid is a soluble fatty acid of C₁₋₆ or water soluble carboxylate thereof.

48. The wastewater treatment process according to claim 44 further comprising recycling a portion of the settled sludge (ii) of the final settling zone (f) back to the first anoxic section (I) of the second anoxic zone of (c).

49. The wastewater treatment process according to claim 44 further comprising recycling a portion of the settled sludge (ii) of the final settling zone (f) back to the second section (II) of the second anoxic zone of (d).

50. The wastewater treatment process according to claim 44 further comprising recycling a portion of the settled sludge (ii) of the final settling zone (f) back to the first anoxic section (I) of the second anoxic zone of (c) and a portion back to the second section (II) of the second anoxic zone of (d).

51. A wastewater treatment process providing nitrogen, phosphorus, biochemical oxygen demand (BOD) and suspended solids removal comprising:
a. passing wastewater containing ammonia nitrogen, phosphate, BOD and suspended solids to a first anoxic zone therein reducing at least some nitrate in a recycled stream from (g);
b. passing the effluent of the first anoxic zone to a first aerobic zone where at least some of the BOD is oxidized and at least some of the ammonia nitrogen is oxidized to nitrate nitrogen;
c. passing the effluent of the first aerobic zone and volatile fatty acid to a first section (I) of a second anoxic zone where phosphorus is released into a liquid wastewater phase and nitrate is reduced;
d. passing the effluent of a first section (I) of a second anoxic zone to a second section (II) of a second anoxic zone;
e. passing the effluent from the second section (II) of a second anoxic zone including the volatile acid to a second aerobic zone where phosphorus is absorbed into the biomass and at least some of the ammonia nitrogen is partially removed and partially oxidized;
f. passing the effluent from the second aerobic zone to a final settling zone therein separating
(i) a purified wastewater having a decreased nitrogen, phosphorus, BOD and suspended solids, and
(ii) a sludge containing suspended solids, phosphate and BOD; and
(g) recycling at least a portion of the sludge (ii) to the first anoxic zone of (a).

52. The wastewater treatment process according to claim 51 further comprising recycling a portion of the contents at the end of the first aerobic zone (b) back to the first anoxic zone of (a).

53. The wastewater treatment process according to claim 51 further comprising passing the wastewater containing ammonia nitrogen, phosphate, BOD, and suspended solids though a primary solids separation zone where a portion of the BOD and suspended solids is removed before passing the wastewater to the first anoxic zone (a).

54. The wastewater treatment process according to claim 51 wherein the volatile fatty acid is a soluble fatty acid of C₁₋₆ or water soluble carboxylate thereof.

55. The wastewater treatment process according to claim 51 further comprising recycling a portion of the settled sludge (ii) of the final settling zone (f) back to the first anoxic section (I) of the second anoxic zone of (c).

56. The wastewater treatment process according to claim 51 further comprising recycling a portion of the settled sludge (ii) of the final settling zone (f) back to the second section (II) of the second anoxic zone of (d).

57. The wastewater treatment process according to claim 51 further comprising recycling a portion of the settled sludge (ii) of the final settling zone (f) back to the first anoxic section (I) of the second anoxic zone of ® and a portion back to the second section (II) of the second anoxic zone of (d).
